(19) United States
(12) Patent Application Publication
(10) Pub. No.: US 2007/0091133 A1
(43) Pub. Date: Apr. 26, 2007

(54) MICROINJECTION APPARATUS WITH THERMOCHROMIC INDICATOR

(76) Inventors: Chung-Cheng Chou, Taoyuan (TW); William Wang, Taoyuan (TW); Chen Peng, Taoyuan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/536,148

(22) Filed: Sep. 28, 2006

(30) Foreign Application Priority Data
Oct. 21, 2005 (TW) 094136799

(51) Int. Cl. B41J 29/38

(52) U.S. Cl. 347/14

(57) ABSTRACT

The invention provides a microinjection apparatus for a fluid. The microinjection apparatus comprises a substrate, a manifold, at least one fluid chamber, and at least one thermal sensing film. The manifold is formed on the substrate for containing the fluid therein. The at least one fluid chamber is also formed on the substrate and in communication with the manifold. Furthermore, the fluid chamber has a respective orifice and a respective heater disposed adjacent to the orifice. In addition, the thermal sensing film corresponds to the fluid chamber and is formed on a surface adjacent to the orifice. It should be noticed that the thermal sensing film has a respective color changeable in response to a heat generated during operation of the corresponding heater.

### BACKGROUND OF THE INVENTION

1. Field of the Invention

The present invention relates to a microinjection apparatus, more particularly, to a microinjection apparatus with thermochromic indicator.

2. Description of the Prior Art

Development of Microtechnology has brought evolutionary impact to certain fields of technology, such as information, communication, consumer electrical component, and biotechnology. In the field of Microtechnology, microfluidic system is related to design, construct and produce the apparatus and process for operating micro-fluid. Microinjection apparatus is a microfluidic system widely applied today. Furthermore, microinjection apparatus has been applied in, such as ink-jet printer, biochemical assay, pharmaceutical screening, fuel injection system, and chemical synthesis.

Microinjection apparatus can mainly be classified to thermal bubble type and piezoelectric type. At present, thermal bubble microinjection apparatus has been widely applied to producing high quality, low cost image and data output with computer printers, facsimile machines and potentially with copiers and other devices as well. Thermal bubble microinjection apparatus uses thermal energy selectively produced by a heater. The heater is disposed adjacent to an orifice of a fluid chamber filled with a fluid. When the heater receives a firing signal, it will heat the fluid to generate a bubble in the fluid chamber to serve as a valve to eject the fluid. Furthermore, each temporary bubble expels a fluid droplet and propels it toward a recording medium.

Regarding to the requirement of rapid thermal bubble generation of thermal bubble microinjection apparatus, the heating efficiency of the heater becomes an important factor to determine the quality of the microinjection apparatus. Moreover, with the development of microinjection apparatus having high density of orifices, and rapid image data output systems, the heater is required to have shorter reaction time and better heating efficiency. Therefore, the heating efficiency test for the heater should be more rigid, to ensure the microinjection apparatus can match the original design, and supply with precise and stable fluid injection.

At present, many apparatus for detecting the temperature of ink-jet head have been disclosed. For example, U.S. Pat. No. 6,578,942 to Tuhro, et al. discloses a system for sensing the operating temperature of a print head. In the printing system of this disclosure, a liquid crystal temperature sensor is applied to the exterior of the print head cartridge to give an optical indication of the temperature at the print head that is readable by an optical scanner. However, the sensing system of the prior art is not capable of detecting the heating efficiency of the ink-jet head.

In addition, U.S. Pat. No. 5,075,690, U.S. Pat. No. 5,220,345 and U.S. Pat. No. 5,315,316 disclose solid electronic temperature sensors disposed within the print head. However, problems arise because of sensor design, the difficulties of calibration, and changes due to mounting stress, encapsulation shifts, vibration, noise and other influences. Furthermore, to perform the heating efficiency test, extra apparatus have to be disposed, even the processes have to be stopped. Obviously, the production cost and time are both elevated by these test processes.

### SUMMARY OF THE INVENTION

Accordingly, a scope of the invention, therefore, is to provide a microinjection apparatus with thermochromic indicator which overcomes the drawbacks of the prior art. By applying the thermochromic indicator, the heating efficiency can be determined at wafer level before dicing. Furthermore, inspectors can determine the quality and normality of the circuit of the heater on the microinjection apparatus at wafer level by their eyes and without extra apparatus.

In a preferred embodiment of the present invention, the microinjection apparatus for a fluid includes a substrate, a manifold, at least one fluid chamber, and at least one thermal sensing film. The manifold is formed on the substrate for containing the fluid therein. The at least one fluid chamber is also formed on the substrate and in communication with the manifold. Furthermore, the fluid chamber has a respective orifice and a respective heater disposed adjacent to the orifice. In addition, the thermal sensing film corresponds to the fluid chamber and is formed on a surface adjacent to the orifice. It should be noticed that the thermal sensing film has a respective color changeable in response to a heat generated during operation of the corresponding heater.

Another scope of the invention is to provide an ink-jet printing system. In a preferred embodiment, the ink-jet system includes at least one ink cartridge which each is equipped with a respective ink-jet chip, an optical detecting device, and a processing device.

In addition, the ink-jet chip includes a substrate, a manifold, at least one fluid chamber, and at least one thermal sensing film. The manifold is formed on the substrate, for containing an ink therein. Furthermore, the at least one fluid chamber is also formed on the substrate and in communication with the manifold. Moreover, the fluid chamber has a respective orifice and a respective heater disposed adjacent to the orifice. The at least one thermal sensing film corresponds to the fluid chamber and is formed on a surface adjacent to the orifice. Furthermore, the thermal sensing film has a respective color changeable in response to a heat generated during operation of the corresponding heater.

The optical detecting device is mounted in operative association with the at least one thermal sensing film to sense the colors indicated by the at least one thermal sensing film and to generate a signal relative thereto.

Additionally, the processing device is electrically connected to the optical detecting device, for processing said signal for using in controlling the operation of said ink-jet printing system.

The advantage and spirit of the invention may be understood by the following recitations together with the appended drawings.

### BRIEF DESCRIPTION OF THE APPENDED DRAWINGS

FIG. 1A is a plan view of a microinjection apparatus 1 according to the preferred embodiment of the invention.

FIG. 1B is a sectional view along line A-A of the microinjection apparatus 1 as shown in FIG. 1A.

FIG. 2 shows the microinjection apparatus of the present invention at wafer level.

FIG. 3 is a flow chart of heating efficiency and heat dissipating efficiency test of the circuit of the heater at wafer level according to an embodiment of the present invention.

FIG. 4 is a functional block diagram of an ink-jet printing system 3 according to an embodiment of the invention.

### DETAILED DESCRIPTION OF THE INVENTION

The present invention provides a microinjection apparatus with thermochromic indicator. The preferred embodiment according to the present invention is disclosed as follow.

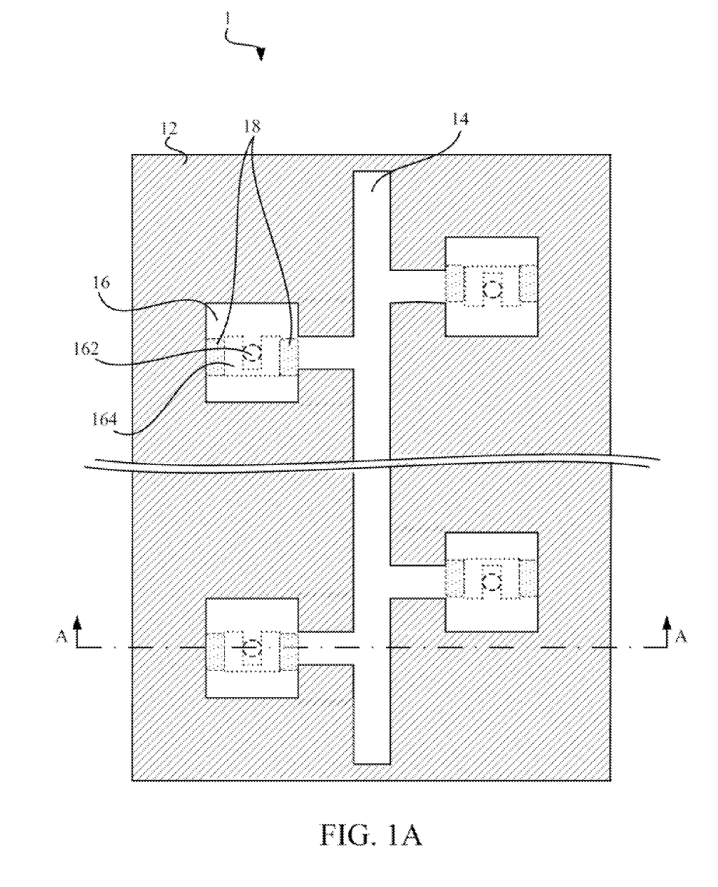

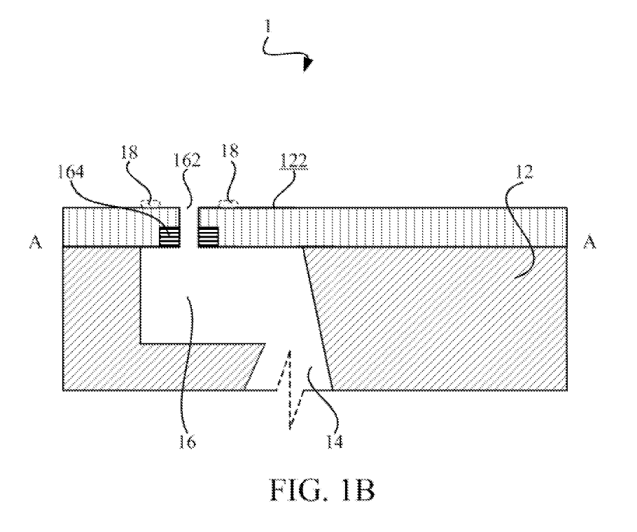

Referring to FIG. 1A and FIG. 1B, which show a microinjection apparatus 1 for a fluid according to a preferred embodiment of the present invention. FIG. 1A is a plan view of the microinjection apparatus 1, whereas FIG. 1B is a sectional view along line A-A of the microinjection apparatus 1 shown in FIG. 1A, to illustrate the corresponding position of each device within the microinjection apparatus 1.

As shown in FIG. 1A and FIG. 1B, the microinjection apparatus 1 of the present invention includes a substrate 12, a manifold 14, a plurality of fluid chambers 16 and a plurality of thermal sensing films 18.

In addition, the manifold 14 is formed on the substrate 12 for containing the fluid (not shown) therein, and further supplying the fluid to the fluid chambers 16. The fluid chambers 16 are also formed on the substrate 12 and in communication with the manifold 14, therefore, the fluid in the manifold 14 can be equally distributed to each of the fluid chambers 16. Moreover, each of the fluid chambers 16 has a respective orifice 162 and a respective heater 164 disposed adjacent to the orifice 162. The heater 164 is used to serve as a virtual valve to eject the fluid when the fluid chamber 16 is filled with the fluid.

In an embodiment, the fluid can be a liquid, such as an ink, a pharmaceutic agent, a biochemical testing agent, and a fuel.

Additionally, the thermal sensing films 18 are corresponded to the fluid chambers 16. As shown in FIG. 1B, each of the thermal sensing films 18 is formed on a surface 122 adjacent to the orifice 162. Furthermore, the thermal sensing film 18 can be disposed adjacent or on the corresponding fluid chamber 16, and it has a respective color changeable in response to a heat generated during operation of the corresponding heater 164. In one embodiment, the thermal sensing film 18 can be formed adjacent to the orifice 162 of the corresponding fluid chamber 16.

In one embodiment, the thermal sensing film 18 can be formed by coating one of at least one thermochromic material on the surface 122. In practice, the chromatic reaction of the thermochromic material is a reversible reaction. Furthermore, the reaction temperature is between 10° C. to 100° C.

In one embodiment, the thermochromic material as described above can includes, for example, a thermochromic liquid crystal, a thermochromic fatty acid, a lactone, a thermoplastic rubber, or a thermochromic dye. In practice, the thermochromic material can be a hydrophobic material.

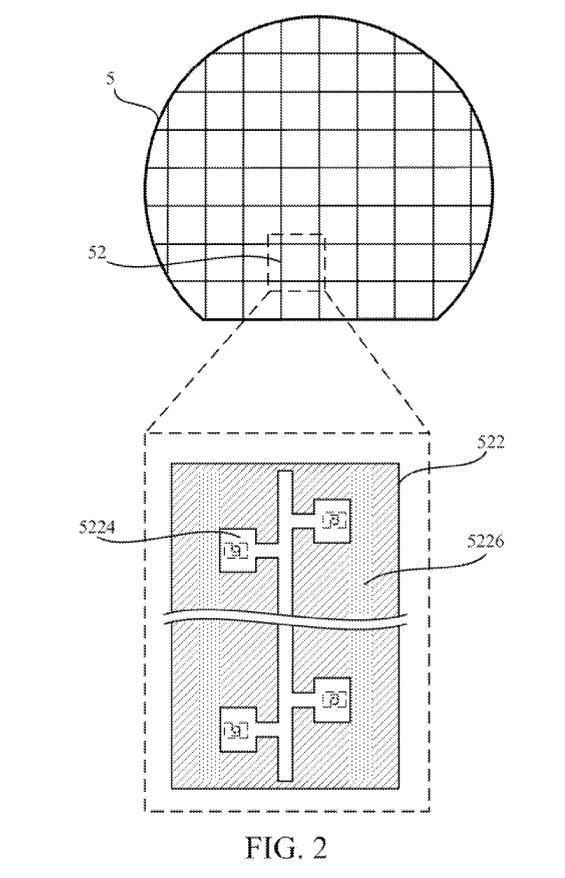

Please refer to FIG. 2, which illustrates the microinjection apparatus 522 of the present invention at wafer level before dicing. In an embodiment, the wafer 5 can be diced into a plurality of chips 52. Each of the chips 52 can further be formed a corresponding microinjection apparatus 522. After the formation of the microinjection apparatus 522, the plurality of chips 52 can be cut from the wafer 5. Furthermore, a thermochromic material is coated adjacent to the fluid chambers 5224 of the corresponding microinjection apparatus 522 on the chips 52 to form the thermal sensing films 5226. Also, the chromatic reaction of the thermochromic material is a reversible reaction.

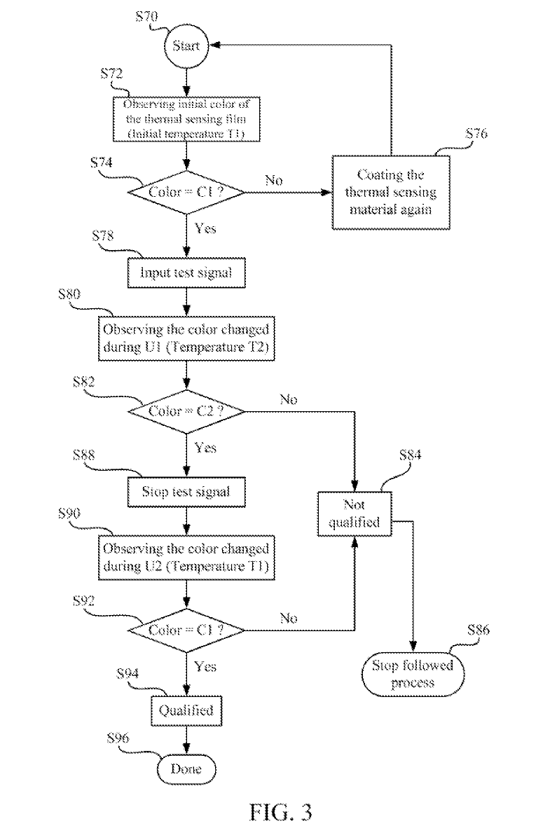

Referring to FIG. 3, a flow chart of heating efficiency and heat dissipating efficiency test of the circuit of the heater at wafer level according to the embodiment described above. After the formation of the thermal sensing film, the testing process started (S70). First of all, observing the color of the thermal sensing film under the temperature T1 (S72), and determining if the color is C1, which corresponds to the initial temperature T1 (S74). If yes, continuing the test and input a test signal (S78), or coating the thermal sensing material again (S76). After the heater received the signal, the circuit of the heater connected, and the heater begin to heat from temperature T1 to temperature T2. In the meanwhile, observing the color of the thermal sensing film (S80), and determining if the color of the film changed from C1 to C2, which corresponds to temperature T2, within unit time U1 (S82).

If the color of the thermal sensing film is still C1, or the color changed from C1 to C2 in more than the unit time U1, the heater is determined to be broken or with low heating efficiency. Accordingly, the microinjection apparatus is determined to be not qualified (S84), and the continued process has to be stopped (S86). On the contrary, if the color of the thermal sensing film changed from C1 to C2 during the unit time U1, the circuit of the heater is determined to be normal, and the heating efficiency of the heater is determined to be qualified. Thereafter, stop the test signal (S88), to cause a break of the circuit of the heater, and the temperature of the heater decreased from T2 to T1 during another unit time U2. In the meanwhile, observing the color of the thermal sensing film (S90), and determining if the color of the film changed from C2 to C1, which corresponds to temperature T1, within unit time U2 (S92).

If the color of the thermal sensing film is still C2, or the color changed from C2 to C1 in more than the unit time U2, the heater is determined to be broken or with low heat dissipating efficiency. Accordingly, the microinjection apparatus is determined to be not qualified (S84), and the continued process has to be stopped (S86). On the contrary, if the color of the thermal sensing film changed from C2 to C1 during the unit time U2, the circuit of the heater is determined to be normal, and the heat dissipating efficiency of the heater is determined to be qualified. Accordingly, the microinjection apparatus is qualified (S94), and finishing the test process (S96).

It should be noticed that the initial temperature T1, temperature T2, unit time U1, and unit time U2 are not consistent, but set after experiments according to the test environment, properties of the microinjection apparatus and characters of the thermal sensing film.

Obviously, through the testing process as described above, inspectors can determine the quality and normality of the circuit of the heater on the microinjection apparatus of the wafer. Furthermore, the inspectors only have to observing the changed color of the thermal sensing film during the unit time with their eyes.

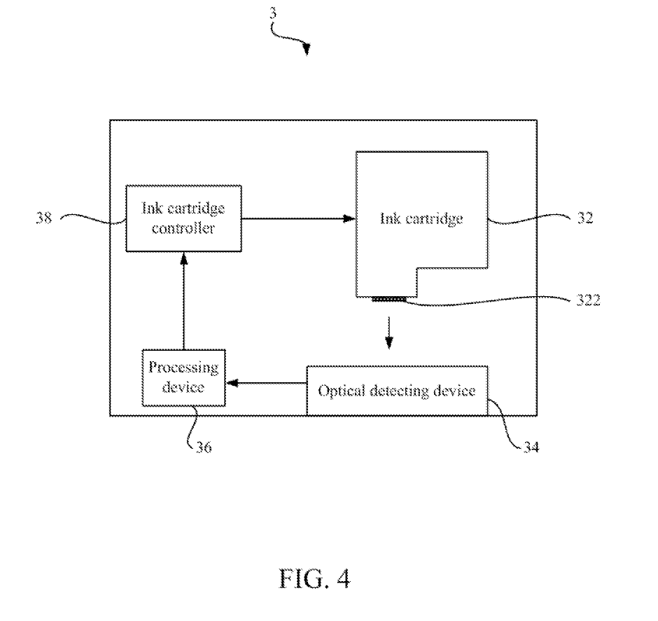

Please refer to FIG. 4. FIG. 4 is a functional block diagram of an ink-jet printing system 3 according to an embodiment of the invention. The ink-jet printing system 3 includes at least one ink cartridge 32, an optical detecting device 34, and a processing device 36.

Each of the ink cartridge 32 is filled with a ink and equipped with a respective ink-jet chip 322. In addition, the ink-jet chip 322 is a microinjection apparatus for injecting the ink in the ink cartridge 32. Moreover, the ink-jet chip 322 includes a substrate, a manifold, at least one fluid chamber, and at least one thermal sensing film.

Since the material and function of the devices, and the operative associations therebetween of the ink-jet chip 322, are the same as the microinjection apparatus described above, unnecessary details will not be given here.

The optical detecting device 34 is mounted in operative association with the at least one thermal sensing film of the ink-jet chip 322 to sense the colors indicated by the thermal sensing films and to generate a signal relative thereto.

Furthermore, as shown is FIG. 4, the processing device 36 is electrically connected to the optical detecting device 34, for processing said signal for using in controlling the operation of the ink-jet printing system 3. In practice, the signal can be converted into digital signal by the processing device 36. The processing device 36 can further be electrically connected to and pass the digital signal to an ink cartridge controller 38. According to the signal, the ink cartridge controller 38 can adjust the action of the heater of the ink-jet chip 322, to achieve the optimal printing quality with economical ink consumption.

In practice, a user operating system also can be electrically connected to the ink-jet printing system. When the volume of filled ink is insufficient with a result that a heat generated during operation of the ink cartridge, the thermal sensing film of the ink-jet chip will senses the heat and changes the color thereof. Accordingly, the processing device of the ink-jet printing system can pass the digital signal to the user operating system to warning the user to change the ink cartridge.

In practice, the ink-jet printing system can further includes a reflecting device, an optical path device and an observing window. When the volume of filled ink is insufficient with a result that a heat generated during operation of the ink cartridge, the thermal sensing film of the ink-jet chip will senses the heat and changes the color thereof. Accordingly, the reflecting device can reflect the changed color to the optical path device, and the optical path device can guide the changed color to the observing window. Therefore, through the observing window, the user can obtain the information about insufficient ink.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A microinjection apparatus for a fluid, comprising:
a substrate;
a manifold, formed on the substrate, for containing the fluid therein;
at least one fluid chamber, formed on the substrate and in communication with the manifold, the fluid chamber having a respective orifice and a respective heater disposed adjacent to the orifice; and
at least one thermal sensing film which corresponds to the fluid chamber and is formed on a surface adjacent to the orifice, the thermal sensing film having a respective color changeable in response to a heat generated during operation of the corresponding heater.

2. The microinjection apparatus of claim 1, wherein the at least one thermal sensing film is formed by coating one of at least one thermochromic material on the surface.

3. The microinjection apparatus of claim 2, wherein the at least one thermochromic material comprises one selected from the group consisting of a thermochromic liquid crystal, a thermochromic fatty acid, a lactone, a thermoplastic rubber, and a thermochromic dye.

4. The microinjection apparatus of claim 1, wherein the at least one thermal sensing film is formed adjacent to the orifice of the corresponding fluid chamber.

5. The microinjection apparatus of claim 1, wherein the fluid is an ink.

6. An ink-jet printing system, comprising:
at least one ink cartridge which each is equipped with a respective ink-jet chip, each of the at least one ink-jet chip comprising:
a substrate;
a manifold, formed on the substrate, for containing an ink therein;
at least one fluid chamber, formed on the substrate and in communication with the manifold, the fluid chamber having a respective orifice and a respective heater disposed adjacent to the orifice; and
at least one thermal sensing film which corresponds to the fluid chamber and is formed on a surface adjacent to the orifice, the thermal sensing film having a respective color changeable in response to a heat generated during operation of the corresponding heater;
an optical detecting device, mounted in operative association with the at least one thermal sensing film to sense the colors indicated by the thermal sensing films and to generate a signal relative thereto; and
a processing device, electrically connected to the optical detecting device, for processing said signal for using in controlling the operation of said ink-jet printing system.

7. The ink-jet printing system of claim 6, wherein the at least one thermal sensing film is formed by coating one of at least one thermochromic material on the surface.

8. The microinjection apparatus of claim 7, wherein the at least one thermochromic material comprises one selected from the group consisting of a thermochromic liquid crystal, a thermochromic fatty acid, a lactone, a thermoplastic rubber, and a thermochromic dye.

9. The microinjection apparatus of claim 6, wherein the at least one thermal sensing film is formed adjacent to the orifice of the corresponding fluid chamber.
